(19) United States
(12) Patent Application Publication
(10) Pub. No.: US 2018/0195615 A1
(43) Pub. Date: Jul. 12, 2018

(54) Liner with Seal for Rotor of Centrifugal Separator

(71) Applicant: MANN+HUMMEL GmbH, Ludwigsburg (DE)

(72) Inventors: Nigel Burford, Taunton (GB); Jian Zou, Shanghai (CN)

(21) Appl. No.: 15/912,728

(22) Filed: Mar. 6, 2018

Related U.S. Application Data
(63) Continuation of application No. PCT/CN2015/089017, filed on Sep. 7, 2015.

(51) Int. Cl. F16J 15/16; B04B 1/08; B04B 15/06

(52) U.S. Cl. CPC F16J 15/164; B04B 15/06; B04B 1/08

(57) ABSTRACT

A centrifugal separator is provided with a stationary casing defining an enclosure. A rotor is rotatably mounted in the enclosure and has a drum body, a base separably connected to the drum body, and a cover separably connected to the drum body opposite the base. A first annular sealing element is disposed between the drum body and the base. A second annular sealing element is disposed between the drum body and the cover. A removable liner is disposed inside the drum body. The removable liner and at least one of the first and second annular sealing elements are formed together as a one-piece element comprised of a resilient material.

### CROSS-REFERENCE TO RELATED APPLICATIONS

This application is a continuation application of international application No. PCT/CN2015/089017 having an international filing date of 07 Sep. 2015 and designating the United States, the entire contents of the aforesaid international application being incorporated herein by reference.

### TECHNICAL FIELD This invention relates to a liner for the rotor of a centrifugal separator and to a centrifugal separator incorporating such a liner.

### BACKGROUND OF THE INVENTION

Centrifugal separators are well known for removing contaminant particles from the lubricating oil circuit of internal combustion engines and for separating particulate matter from liquids or separating liquids of different densities in a variety of industrial processes. As contaminants accumulate within a centrifuge rotor, it is essential that the rotor is routinely cleaned out in order to maintain effectiveness of operation. Typically, a rotor of such a separator comprises a tubular drum body having a separable base and separable cover as end closures. Paper inserts are commonly used to line the interior of the tubular drum to aid cleaning in that contaminant particles become caked onto the insert, which is removable and disposable, instead of on the inner surface of the drum. However, such paper inserts may stick to the inside of the rotor drum, e.g. due to corrosion of the drum material, making their removal more difficult during servicing. In this respect, a centrifugal separator when fitted to a marine engine, a land vehicle engine or any other industrial engine is likely to require cleaning at least once a month, typically after anywhere from 500 to 800 operating hours. Also, problems can arise when paper inserts not specifically designed for the relevant rotor are employed as liners as these may disintegrate, distort and even slump into the rotor during operation, causing vibration and contamination issues.

O-ring seals are employed between the drum body of the rotor and the respective base and cover. Grooves in which these seals are mounted need to be kept clean and free of contaminant material for optimum performance of the separator. This requires additional checking and cleaning at each service interval when the liner is removed and can be difficult to achieve. This can result in leakage of the seals which can cause uneven build-up of contaminant in the rotor resulting in excessive vibration which in turn can lead to accelerated bearing wear, fatigue damage to the centrifuge bracket, and excessive noise. In any event, these rotor seals also need replacing at intervals due to damage by misuse and/or time-dependent material degradation. Replacement may be necessary at between 6 to 12 months.

### SUMMARY OF THE INVENTION

An object of the present invention is to mitigate these problems.

A first aspect of the present invention is a centrifugal separator comprising a stationary casing defining an enclosure, a rotor which is rotatably mounted in the enclosure and comprises a drum body with separable base and separable cover as end closures and respective annular sealing elements between the body and each of the base and the cover, and a removable liner inside the drum body, the liner comprised of resilient material and provided in one piece with at least one of the sealing elements.

A further aspect of the invention is a liner of resilient material for insertion into a drum body of a rotor of a centrifugal separator, the liner being provided in one piece with an annular sealing element for mounting between the drum body and a separable base of the rotor or for mounting between the drum body and a separable cover of the rotor. In other words, the liner is provided in one piece with one of the sealing elements, while the other sealing element remains separate and maybe a conventional O-ring seal.

However, in a further embodiment, a liner of resilient material in accordance with the invention, for insertion into a drum body of a rotor of a centrifugal separator, may be provided in one piece with respective annular sealing elements, one at each end of the liner, one for mounting between the drum body and a separable base, and the other for mounting between the drum body and a separable cover.

The liner is preferably formed of elastomeric material. Rubber is found to be suitable. A suitable thickness may be in the region of 2 mm to 3 mm. The seal or each seal can then be formed as a radially deflected end margin of the liner, which is preferably in the form of a continuous sleeve to be fitted to the interior of the rotor drum body.

Combining the lining and sealing functions in one article ensures that they are cleaned together and replaced together which streamlines the servicing operation and reduces the potential for failure in servicing compared to the current situation. The seal and its seating will be more reliably cleaned at each service interval. This will reduce the likelihood of problems arising with the seal. The liner will be reusable and will therefore require cleaning, but it will be more reliable in its fitting to and removal from the interior of the drum body. The liner and seal together will be replaced after several service intervals.

### BRIEF DESCRIPTION OF THE DRAWINGS

The invention will be described further, by way of example, with reference to the accompanying drawings.

FIG. 1 is a longitudinal cross section through a practical embodiment of a centrifugal separator having a removable liner in accordance with the present invention.

FIGS. 2a and 2b are enlarged detailed views, respectively, of an upper region of the liner and a lower region of the liner of the centrifugal separator of FIG. 1.

FIG. 3 is a similar enlarged detail view of an upper region of the liner and adjacent O-ring seal in an alternative embodiment of the invention.

### DETAILED DESCRIPTION OF THE DRAWINGS

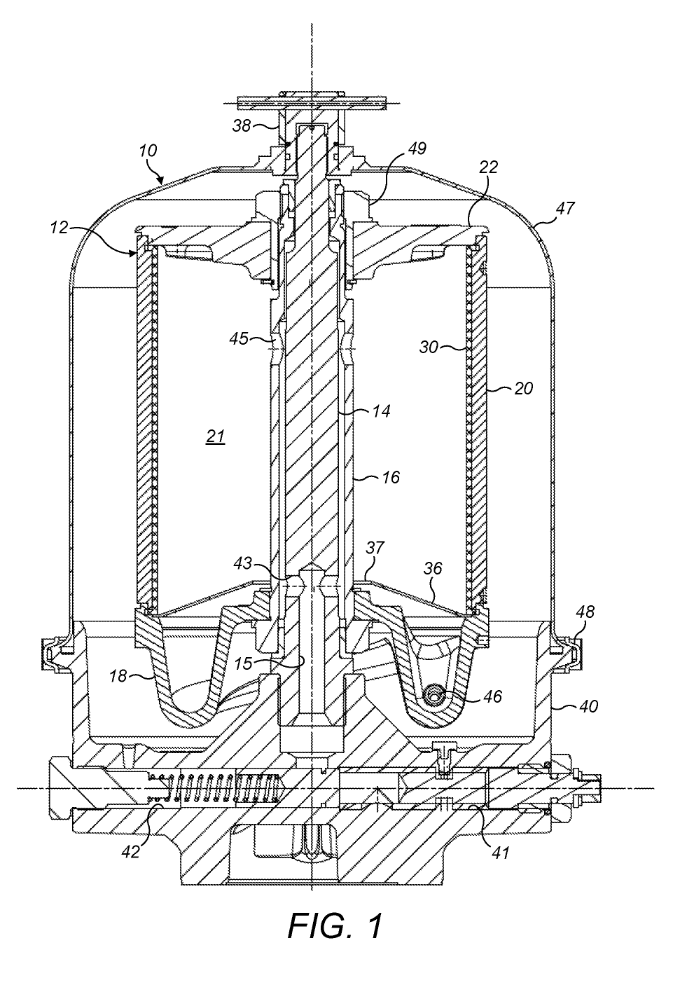

As illustrated in FIG. 1, an exemplary embodiment of a self-powered centrifugal separator according to the invention comprises a stationary casing 10 defining an enclosure and further comprises a rotor 12 which is mounted in the enclosure so as to be rotatable upon a substantially vertical spindle 14. The rotor 12 has a central tube 16 located on the spindle 14, a base 18, a drum body 20 and a top cover 22. The top cover 22 is detachable from the drum body 20 and the drum body 20 is detachable from the base 18 to enable regular cleaning of the rotor drum. A liner 30 of elastomeric material is provided on the inner surface of the drum body 20. A suitable material for the liner is rubber or synthetic rubber. A suitable thickness is 2 mm to 3 mm. Viton rubber with a Shore (A) hardness of about 70 is suitable. However, this is provided only by way of example and other materials and other dimensions will also be suitable.

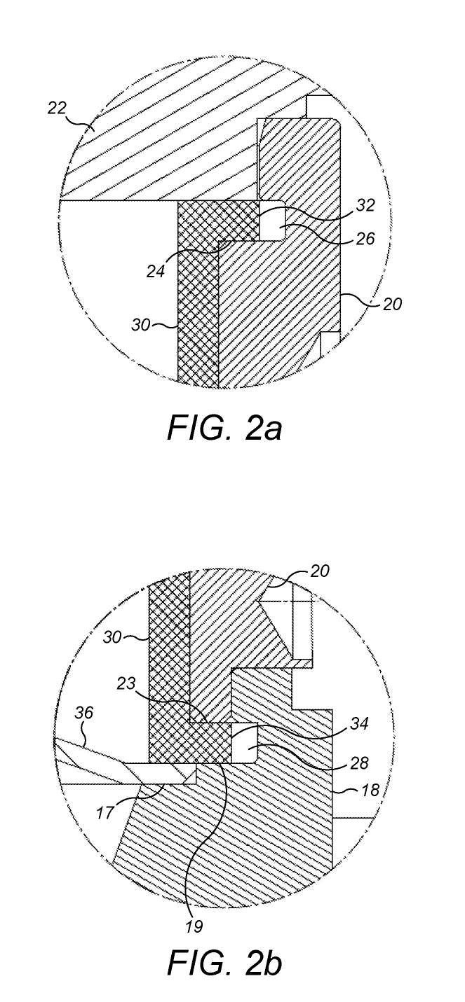

The liner 30 is in the form of a one-piece element or one-piece sleeve. At each of the upper and lower ends of the liner body, an end margin of the liner 30 is deflected outwards to provide a respective annular sealing element 32, 34, as shown in greater detail in FIGS. 2a and 2b. As shown, these integrally provided sealing elements 32, 34 are captured between annular surfaces at the upper and lower ends of the drum body 20 and the top cover 22 and the base 18, respectively, and thereby provide reliable sealing, in this case in the axial direction.

In this particular illustrated embodiment, as shown in FIG. 2a, the upper sealing element 32 is retained between an annular shoulder 24 formed adjacent to the upper end of the drum body 20 and a lower surface of the top cover 22, with a radial space 26 to allow for variation in size of the sealing element 32 and deformation of the sealing element 32. As shown in FIG. 2b, the lower sealing element 34 is retained between an annular shoulder 19 formed adjacent to an outer edge of the base 18 and a lower end surface 23 of the drum body 20, again with a radial space 28 to allow for variation in size of the sealing element 34 and in deformation of the sealing element 34 as it is compressed to provide the sealing action. Both the lower end of the drum body 20 and the outer edge of the base 18 are suitably configured with rebates to ensure accurate location and engagement upon repeated disassembly and reassembly when the rotor 12 is cleaned and serviced. Additionally, in this particular illustrated version, provision is made for seating of an edge of a rotor chamber divider 36 in a recess 17 formed in the base 18, with the sealing element 34 held in contact with the edge of the divider 36 as well as the surface 19 of the base 18.

The remaining structure of the illustrated embodiment is conventional for a self-driven centrifugal separator, that is to say where the rotor 12 is driven by means of the fluid which passes there through and from which contaminant particles are to be separated in the rotor. Accordingly, only a brief description is provided. A lower section 40 of the stationary casing 10 includes respective passages 41, 42 for inflow and outflow of the working fluid, from which the contaminant particles are to be separated. The spindle 14 is mounted to the lower section 40 and is provided with an axial bore 15 in communication with the inflow passage 41. Radial openings 43 in the spindle 14 and further radial openings 45 in the rotor tube 16 allow for flow of working fluid to the rotor chamber 21. The rotor base 18 includes outlet nozzles 46, only one of which is shown in

FIG. 1. Typically there is a symmetrically arranged pair of nozzles 46 which are provided at a radial distance from the axis of the spindle 14 and are configured to direct fluid exiting the rotor 12 in a direction tangential to the rotor 12. This tangential emission of fluid drives the rotor 12 and generates a centrifugal force within the rotor chamber 21 which separates contaminant particles by causing them to adhere to or accumulate on the inner surface of the sleeve 30 which lines the rotor body 20.

The divider 36, which is frusto-conical in shape and defines an opening 37 surrounding the rotor tube 16 is typically provided inside the rotor chamber 21. It serves to direct the flow of fluid in the chamber 21 from a generally downward direction adjacent the inner surface of the drum body 20 back up towards the opening 37. This slows the rate of flow of fluid and thereby enhances separation of particulate matter and also prevents accumulated particulate matter from descending and potentially clogging the nozzles 46.

The casing 10 is completed by a domed upper section 47 which is attached to the lower section 40, e.g. by clips or retention band 48. The spindle 14 extends upwards from its journal in the lower section 40, through a bearing arrangement 49 in the top cover 22 to a further journal in a connector fitment 38 at the top of the casing upper section 47.

The rotor 12 must be periodically emptied of the accumulated separated contaminant particulate matter and cleaned. This may be at intervals of about a month, but could be more frequent or less frequent, depending on the operating environment of the separator and the number of operating hours. To do this, the connector fitment 38 and the retention band 48 are released to allow the upper section 47 of the enclosure 10 to be lifted away from the top of the spindle 14 and the lower section 40. The rotor 12 is then accessible and may be removed from the spindle 14. Once the top cover 22 is removed, the drum body 20 can be lifted away from the base 18 and the liner 30 can be cleaned of the accumulated particulate matter. This should be done by removal of the liner 30. Once the liner 30 has been cleaned, it can be re-used, at least for several times before requiring replacement. The cleaned liner 30 can be re-installed by folding it longitudinally and feeding it through the rotor body 20 and pressing it back into contact with the inner surface of the rotor body 20, ensuring that the respective end margins which provide the sealing elements 32, 34 are appropriately deflected to overlie respective radial surfaces 24, 23 at the top and bottom of the rotor body 20. This does not require great manual dexterity and the length of the liner 30 will be chosen to facilitate re-establishment of reliable sealing action by means of these elements 32, 34.

The liner 30 may be of a size slightly larger, by only a few millimeters, than the internal diameter of the rotor body 20 so that, when it is initially fitted and when it is repositioned after each clean, a reliable, even fit can be achieved minimizing likelihood of creasing or trapping of air between the surface of the rotor body 20 and the liner 30.

The advantage of using the liner 30 with integral sealing elements 32, 34 is that it facilitates reliable servicing/cleaning. It avoids the need for additional O-ring seals which require attention to cleaning the grooves in which they are mounted and it avoids use of inappropriate paper liners which can significantly impair performance of a separator. It will be understood and readily apparent to a person skilled in the art that the configuration of the mounting arrangements for providing the seals may be varied in many ways and that the arrangement in FIGS. 2a and 2b only show, as examples, one of many possible mounting arrangements which could be satisfactory.

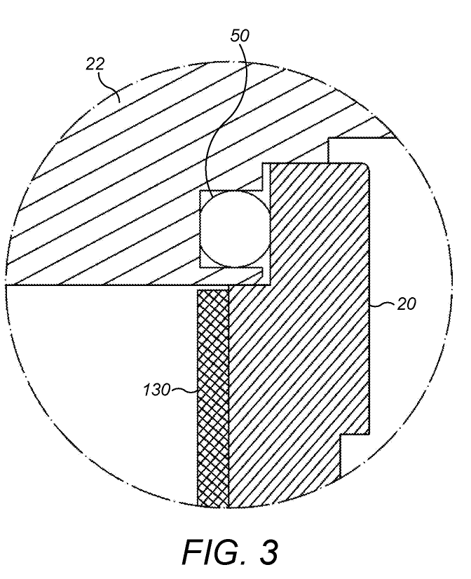

FIG. 3 shows an alternative embodiment where a single O-ring 50 is still used to provide the seal between the rotor top cover 22 and the rotor body 20. The seal at the lower end of the liner 130 is integrally formed and may be as shown in FIG. 2b. Accordingly, certain advantages relative to ease of servicing are still obtained.

The invention is not restricted to the details of any of the foregoing embodiments, and variations are possible within the scope of the appended claims. Moreover, the invention is not limited to a self-driven centrifugal separator and is equally applicable to a centrifugal rotor which is provided with drive means.

Throughout the description and claims of this specification, the words “comprise” and “contain” and variations of them mean “including but not limited to”, and they are not intended to (and do not) exclude other components.

What is claimed is:

1. A centrifugal separator comprising:
a stationary casing defining an enclosure;
a rotor rotatably mounted in the enclosure and comprising a drum body, a base separably connected to the drum body, and a cover separably connected to the drum body opposite the base;
a first annular sealing element disposed between the drum body and the base;
a second annular sealing element disposed between the drum body and the cover;
a removable liner disposed inside the drum, wherein the removable liner and at least one of the first and second annular sealing elements are formed together as a one-piece element comprised of a resilient material.

2. The centrifugal separator according to claim 1, wherein the resilient material is an elastomeric material.

3. A liner for insertion into a drum body of a rotor of a centrifugal separator, the liner comprising a liner body and an annular sealing element configured to be mounted between the drum body and a separable base of the rotor or to be mounted between the drum body and a separable cover of the rotor, wherein the liner body and the annular sealing element are formed together as a one-piece element comprised of a resilient material.

4. The liner according to claim 3, wherein the resilient material is an elastomeric material.

5. A liner for insertion into a drum body of a rotor of a centrifugal separator, the liner comprising a liner body and a first annular sealing element configured to be mounted between the drum body and a separable base of the rotor and further comprising a second annular sealing element configured to be mounted between the drum body and a separable cover of the rotor, wherein the liner body and the first and second annular sealing elements are formed together as a one-piece element comprised of a resilient material.

6. The liner according to claim 5, wherein the resilient material is an elastomeric material.
